(19) United States
(12) Patent Application Publication
(10) Pub. No.: US 2010/0274776 A1
(43) Pub. Date: Oct. 28, 2010

(54) DATA SEARCH APPARATUS, CONTROL METHOD THEREFOR, AND DATA SEARCH SYSTEM

(75) Inventor: Yoshio IIZUKA, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/770,613

(22) Filed: Apr. 29, 2010

Related U.S. Application Data
(63) Continuation of application No. PCT/JP2009/003459, filed on Jul. 23, 2009.

(30) Foreign Application Priority Data
Sep. 25, 2008 (JP) 2008-246599

(51) Int. Cl. G06F 17/30

(52) U.S. Cl. 707/706; 707/E17.014

(57) ABSTRACT

This invention is directed to a technique of extracting, from a case database, a plurality of definite case data similar to an input case. A data search apparatus which extracts definite case data from a case database includes an input acceptance unit for accepting input of case data including at least medical image data, a derivation unit for deriving a similarity between each of the plurality of definite case data stored in the case database and the input case data, a classification unit for classifying the plurality of definite case data stored in the case database into a plurality of diagnosis groups, based on definite diagnosis information included in each of the plurality of definite case data, and an extraction unit for extracting, based on the derived similarity, a predetermined number or more of definite case data from each of the plurality of diagnosis groups.

### CROSS REFERENCE TO RELATED APPLICATIONS

This application is a CONTINUATION of PCT application No. PCT/JP2009/003459 filed on Jul. 23, 2009 which claims priority from Japanese Patent Application No. 2008-246599 filed on Sep. 25, 2008, the disclosures of which are hereby incorporated by reference herein in their entirety.

### TECHNICAL FIELD

The present invention relates to a technique of searching a case database for similar case data.

### BACKGROUND ART

Medical documents and medical images are becoming digital along with recent popularization of medical information systems including a hospital information system (HIS) and picture archiving and communication system (PACS). Medical images (e.g., X-ray image, CT image, and MRI image), which were often viewed on a film viewer after developed on films, are digitized now. Digitized medical images (digital images) are stored in the PACS, and if necessary, read out from it and displayed on the monitor of a terminal. Medical documents such as a medical record are also being digitized. The medical record of a patient can be read out from the HIS and displayed on the monitor of a terminal. An image diagnostician in a digital environment can receive an image diagnosis request form by a digital message. He can read out, from the PACS, medical image data obtained by imaging a patient, and display it on the image diagnosis monitor of a terminal. If necessary, the image diagnostician can read out the medical record of the patient from the HIS and display it on another monitor.

When interpreting a medical image to make an image diagnosis, a doctor sometimes hesitates to decide a diagnosis name if a morbid portion in the image during diagnosis has an unfamiliar image feature or there are a plurality of morbid portions having similar image features. In this case, the doctor may ask advice for another experienced doctor, or refer to documents such as medical books and read the description of an image feature regarding a suspicious disease name. Alternatively, he may examine photo-attached medical documents to search for a photo similar to a morbid portion captured in the image during diagnosis, and read a disease name corresponding to the photo for reference of the diagnosis. However, the doctor may not always have an advisory doctor. Even if the doctor examines documents, he may not be able to locate a photo similar to a morbid portion captured in the image during diagnosis or the description of an image feature. To solve this, apparatuses for searching for a similar cases have been proposed recently. The basic idea of the search apparatus is to support a diagnosis by searching for case data from those accumulated in the past based on some criterion and presenting it to a doctor.

For example, patent reference 1 discloses a technique of accumulating image data diagnosed in the past in a database in correspondence with diagnosis information including findings and a disease name. Patent reference 1 also discloses a technique of, when findings related to an image to be newly diagnosed are input, searching for past diagnosis information including similar findings and displaying corresponding image data and a disease name. Patent reference 2 discloses a technique of detecting a reference case in which an image diagnosis result and definite diagnosis result are different (case in which an image diagnosis is wrong), and registering it in a reference case database. Further, patent reference 2 discloses a reference case search method capable of referring to a necessary reference case image by designating identification information later.

According to the technique described in patent reference 1, both image data and a disease name are obtained as a similar case search result. However, the similarity between image features is not always guaranteed because the search is based on the similarity between texts. Since only the disease name of case data having similar findings is obtained, different disease names may not always be obtained. The technique described in patent reference 2 can call a doctor's attention to a false diagnosis, but cannot always present case data from which the doctor analogizes a correct diagnosis name of an image during image interpretation. When searching for past case data for a given case, a plurality of case data with different definite diagnosis results may not be obtained, which may make it difficult for the doctor to make a decision.

### PRIOR ART REFERENCES

### PATENT REFERENCES

Patent Reference 1: Japanese Patent Laid-Open No. 6-292656

Patent Reference 2: Japanese Patent Laid-Open No.

5-101122

It is an object of the present invention to provide a technique capable of extracting a plurality of case data with different definite diagnosis results when searching for past case data for a given case.

### SUMMARY OF THE INVENTION

To solve the above-described problems, a data search apparatus according to the present invention comprises the following arrangement. That is, a data search apparatus which extracts at least data of one definite case from a case database that stores a plurality of definite case data including medical image data and definite diagnosis information corresponding to the medical image data comprises input acceptance unit for accepting input of case data including at least medical image data, derivation unit for deriving a similarity between each of the plurality of definite case data stored in the case database and the case data input from the input acceptance unit, classification unit for classifying the plurality of definite case data stored in the case database into a plurality of diagnosis groups, based on definite diagnosis information included in each of the plurality of definite case data, and extraction unit for extracting, based on the similarity derived by the derivation unit, at least a predetermined number of definite case data from each of the plurality of diagnosis groups.

To solve the above-described problems, a data search apparatus control method according to the present invention comprises the following steps. That is, a method of controlling a data search apparatus which extracts at least data of data of one definite case from a case database that stores a plurality of definite case data including medical image data and definite diagnosis information corresponding to the medical image data comprises an input acceptance step of accepting input of case data including at least medical image data, a derivation step of deriving a similarity between each of the plurality of definite case data stored in the case database and the case data input in the input acceptance step, a classification step of classifying the plurality of definite case data stored in the case database into a plurality of diagnosis groups, based on definite diagnosis information included in each of the plurality of definite case data, and an extraction step of extracting, based on the similarity derived in the derivation step, at least a predetermined number of definite case data from each of the plurality of diagnosis groups.

To solve the above-described problems, a data search system according to the present invention comprises the following arrangement. That is, a data search system including a case database which stores a plurality of definite case data including medical image data and definite diagnosis information corresponding to the medical image data, and a data search apparatus which accesses the case database to extract at least data of one definite case comprises input acceptance unit for accepting input of case data including at least medical image data, derivation unit for deriving a similarity between each of the plurality of definite case data stored in the case database and the case data input from the input acceptance unit, classification unit for classifying the plurality of definite case data stored in the case database into a plurality of diagnosis groups, based on definite diagnosis information included in each of the plurality of definite case data, and extraction unit for extracting, based on the similarity derived by the derivation unit, at least a predetermined number of definite case data from each of the plurality of diagnosis groups.

The present invention can provide a technique capable of extracting a plurality of case data with different definite diagnosis results when searching for past case data for a given case.

Other features and advantages of the present invention will become apparent from the following description of exemplary embodiments with reference to the accompanying drawings. Note that the same reference numerals denote the same or similar parts throughout the accompanying drawings.

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 is a block diagram showing the device arrangement of a similar case search apparatus according to the first embodiment;

FIG. 2 is a view showing a conceptual relationship between the image feature amount of the region of interest and the diagnosis group in similar case search;

FIG. 3 is a flowchart of processing by the similar case search apparatus according to the first embodiment;

FIG. 4 is a flowchart showing the detailed processing procedures of step S340;

FIG. 5 is a flowchart showing the detailed processing procedures of step S370;

FIG. 6 is a flowchart showing the detailed procedures of some of the processing procedures of step S370 (second embodiment);

FIG. 7 is a view showing a display example of processing results in the similar case search apparatus according to the first embodiment;

FIG. 8 is a view showing a display example of processing results in a similar case search apparatus according to the second embodiment;

FIG. 9A is a table showing an example of a case data table archived in a case database 2;

FIG. 9B is a table showing the example of the case data table archived in the case database 2;

FIG. 10A is a table showing another example of the case data table archived in the case database 2;

FIG. 10B is a table showing the other example of the case data table archived in the case database 2;

FIG. 11 is a table exemplifying a search case data table;

FIG. 12 is a table exemplifying a top similar case data table;

FIG. 13 is a table exemplifying a correspondence table between a plurality of “definite diagnosis names” and “diagnosis group IDs (GIDs)”;

FIG. 14 is a table exemplifying a correspondence table between the “diagnosis group ID (GID)” and a plurality of “related group IDs”;

FIG. 15 is a table exemplifying a correspondence table between the “search target group ID” and the “selection number (lower limit, upper limit)” of similar case data;

FIG. 16 is a table showing a table obtained by sorting the correspondence table of FIG. 15 in ascending order of the “search target group ID”;

FIG. 17 is a table showing an example of a search target group-specific similar case data table; and

FIG. 18 is a table showing another example of the search target group-specific similar case data table.

### DETAILED DESCRIPTION OF THE EMBODIMENTS

Preferred embodiments of the present invention will now be described in detail with reference to the drawings. It should be noted that the following embodiments are merely examples and do not limit the scope of the present invention.

### First Embodiment

A similar case search apparatus in a medical data search system will be exemplified as the first embodiment of a data search apparatus according to the present invention.

<Apparatus Arrangement>

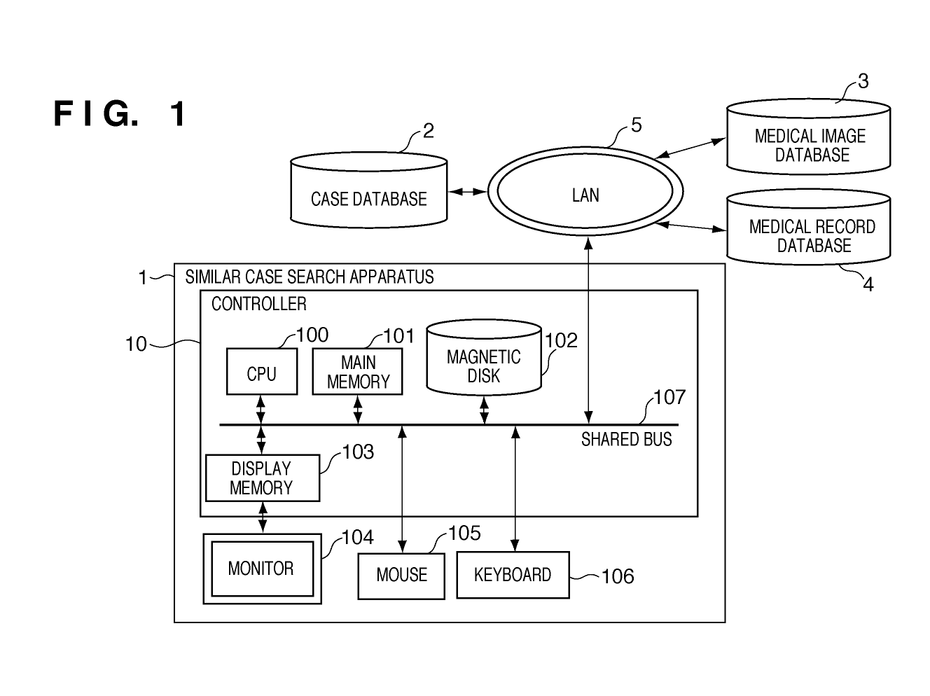

FIG. 1 is a block diagram showing the device arrangement of the similar case search apparatus according to the first embodiment. A similar case search apparatus 1 includes a controller 10, monitor 104, mouse 105, and keyboard 106. The controller 10 includes a central processing unit (CPU) 100, main memory 101, magnetic disk 102, display memory 103, and shared bus 107. The CPU 100 executes programs stored in the main memory 101 to achieve various control operations such as access to a case database 2, medical image database 3, and medical record database 4 and control of the overall similar case search apparatus 1.

The CPU 100 mainly controls the operation of each building component of the similar case search apparatus 1. The main memory 101 stores a control program to be executed by the CPU 100, and provides a work area when the CPU 100 executes a program. The magnetic disk 102 stores an operating system (OS), device drivers for peripheral devices, various kinds of application software including programs for performing similar case search processing and the like (to be described later), and work data generated or used by these software programs. The display memory 103 temporarily stores display data for the monitor 104. The monitor 104 is, for example, a CRT monitor or liquid crystal monitor, and displays an image based on data from the display memory 103. The mouse 105 and keyboard 106 receive a pointing input, a text input, and the like from the user. The shared bus 107 connects these building components so that they can communicate with each other.

In the first embodiment, the similar case search apparatus 1 can read out, via a LAN 5, case data from the case database 2, image data from the medical image database 3, and medical record data from the medical record database 4. The case database 2 functions as a case data archiving unit for archiving a plurality of case data (definite case data) including medical image data and definite diagnosis information corresponding to the medical image data. An existing PACS is usable as the medical image database 3. An electronic medical record system, which is a subsystem of an existing HIS, is available as the medical record database 4. It is also possible to connect external storage devices, for example, a FDD, HDD, CD drive, DVD drive, MO drive, and ZIP drive to the similar case search apparatus 1 and read definite case data, image data, and medical record data from these drives.

Note that medical images include a scout X-ray image (roentgenogram), X-ray CT (Computed Tomography) image, MRI (Magnetic Resonance Imaging) image, PET (Positron Emission Tomography) image, SPECT (Single Photon Emission Computed Tomography) image, and ultrasonic image.

The medical record describes personal information (e.g., name, birth date, age, and sex) of a patient, clinical information (e.g., various test values, chief complaint, past history, and treatment history), reference information to patient's image data stored in the medical image database 3, and finding information of a doctor in charge. After making a diagnosis, a definite diagnosis name is described in the medical record.

Case data archived in the case database 2 is created by copying or referring to some of definite diagnosis name-attached medical record data archived in the medical record database 4 and image data archived in the medical image database 3.

<Data Structure>

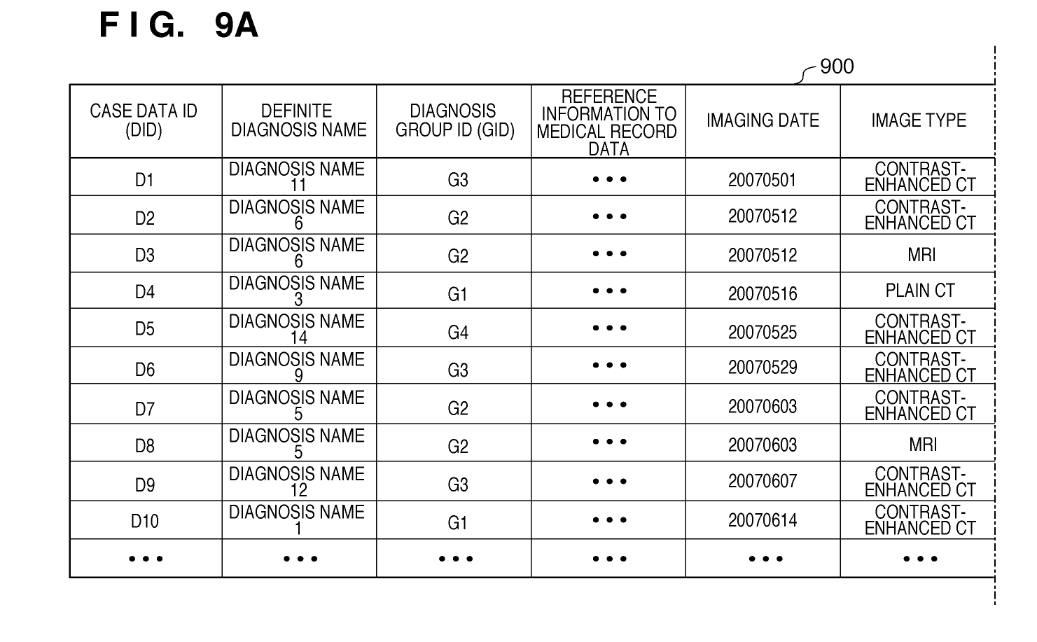

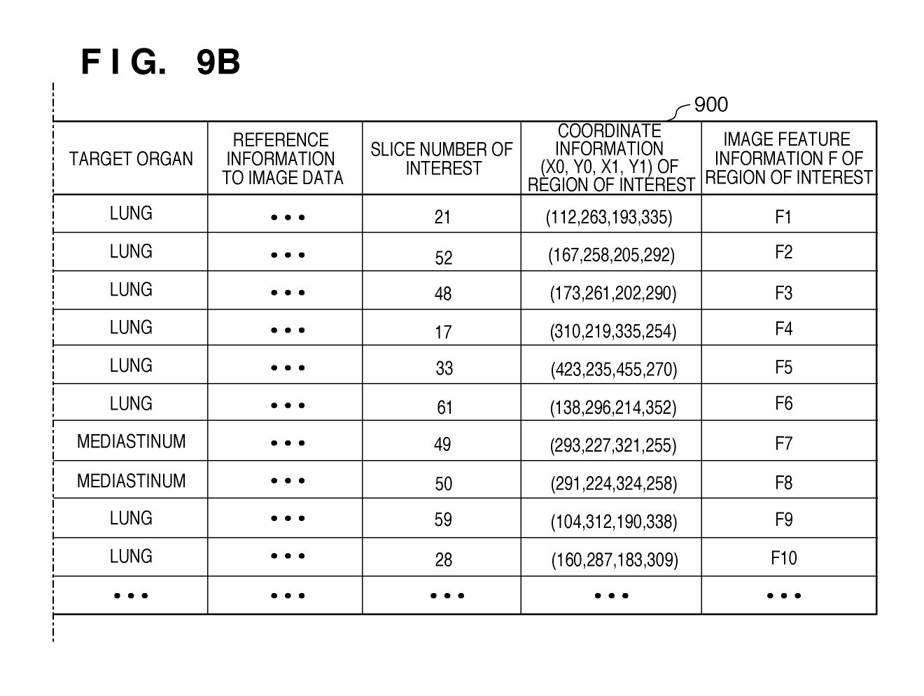

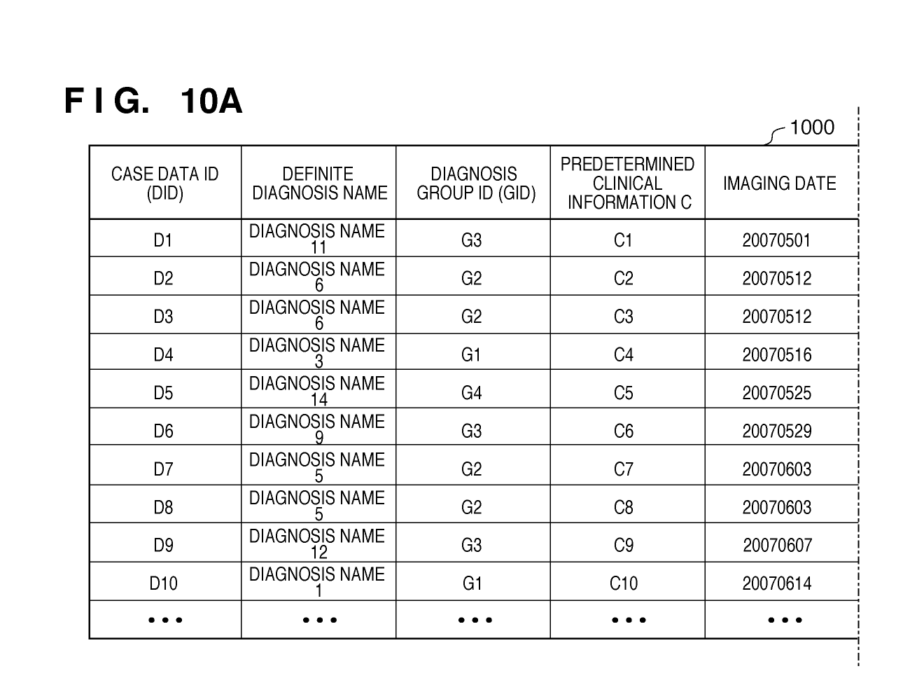

FIGS. 9A and 9B and FIGS. 10A and 10B show examples of case data tables archived in the case database 2. The case data table is a set of case data which are formed from the same components and are arranged regularly.

The components of case data have the following meanings. A “case data ID (DID)” is an identifier for uniquely identifying data of a case. As DIDs, sequential numbers are assigned in the order in which case data were added. A “definite diagnosis name” is obtained by copying a definite diagnosis name described in medical record data. The “definite diagnosis name” need not always be a character string and may use a standard diagnosis code (numerical value uniquely corresponding to a definite diagnosis name). A “diagnosis group ID (GID)” is an identifier for uniquely identifying a diagnosis group. The diagnosis group is a set of definite diagnosis names which need not be identified in image diagnosis. For example, pulmonal diseases are lung cancer, pneumonia, and tuberculosis. These diseases require different medical treatments and need to be discriminated even in image diagnosis. In contrast, lung adenocarcinoma, squamous cell carcinoma, small cell lung cancer, and the like are diagnosed in more detail from lung cancers. It is difficult and unnecessary to distinguish these diseases in image diagnosis, so they are classified into the same diagnosis group as that of lung cancers. Deciding a diagnosis group requires medical knowledge about image diagnosis.

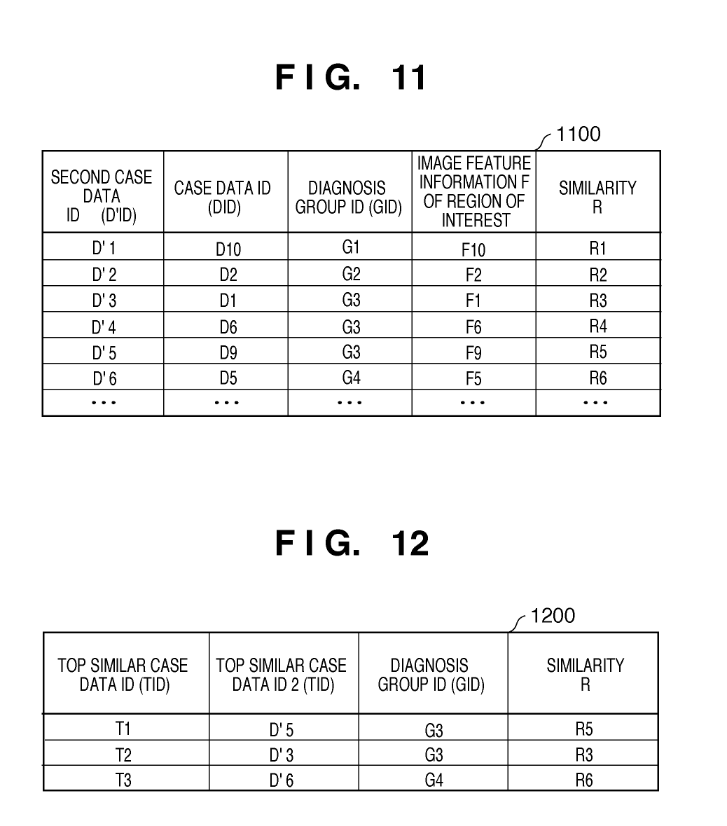

FIG. 13 is a table exemplifying a correspondence table between a plurality of “definite diagnosis names” and “diagnosis group IDs (GIDs)”. Note that FIG. 13 does not show concrete definite diagnosis names. There are many definite diagnosis names for respective medical departments. Further, the same disease is sometimes expressed by different disease names depending on medical institutions. It is therefore desirable to appropriately determine the correspondence table between definite diagnosis names and diagnosis group IDs (GIDs) for each medical department or medical institution which uses the correspondence table.

In the first embodiment, the correspondence table exemplified in FIG. 13 is stored in the magnetic disk 102 of the similar case search apparatus 1 and if necessary, can be rewritten. A person with given authority rewrites the correspondence table according to predetermined procedures. For example, a person with given authority reads out a new correspondence table from an external storage device (not shown) or receives it via the LAN 5, and stores it in the magnetic disk 102, thereby rewriting the correspondence table.

Referring again to a case data table 900, “reference information to medical record data” is reference information for reading out medical record data corresponding to case data from the medical record database 4. “Reference information to medical record data” is stored instead of copying medical record data itself into case data. The case data table can be downsized, saving storage capacity.

An “imaging date” and “image type” can be read out from header information of medical record data or image data. A “target organ” is information representing an organ containing the region of interest of an image (to be described later). A doctor inputs this information when creating case data. The “target organ” can also be automatically input by automatically identifying an organ using the most advanced computer image processing technique.

“Reference information to image data” is reference information for reading out image data corresponding to case data from the medical image database 3. “Reference information to image data” is stored instead of copying image data itself into case data. The case data table can be downsized, saving storage capacity.

A “slice number of interest” is information necessary when the type of medical image is made up of a plurality of slices, like a CT image, MRI image, or PET image. The “slice number of interest” indicates the number of a slice image containing the most concerned region (region of interest) in image diagnosis. “Coordinate information (X0, Y0, X1, Y1) of the region of interest” is information representing an X-Y coordinate range containing the region of interest in a slice image indicated by the “slice number of interest”. In general, coordinate information is expressed as position information of pixels in an orthogonal coordinate system in which the upper left corner of an image is set as the origin, the right direction serves as the X-axis direction, and the down direction serves as the Y-axis direction. Coordinate information (X0, Y0, X1, Y1) represents all the coordinates (X0, Y0) of the upper left corner of the region of interest and the coordinates (X1, Y1) of the lower right corner of it.

The region of interest is obtained as follows. First, image data corresponding to case data is read out from the medical image database 3 using the “reference information to image data”. Then, a slice image designated by the “slice number of interest” is selected. Finally, image data is extracted from a range designated by the “coordinate information (X0, Y0, X1, Y1) of the region of interest”, thereby obtaining image data of the region of interest.

“Image feature information F of the region of interest” is information representing the feature of image data of the region of interest. F is multi-dimensional information (vector information) formed from a plurality of image feature amounts f1, f2, f3, . . . . Examples of the image feature amounts are as follows:
The size of a morbid portion (e.g., diameter such as major axis, minor axis, or mean diameter, and area)
The length of the contour of a morbid portion
The shape of a morbid portion (e.g., the ratio of a major axis and a manor axis, the ratio of the length of a contour and a mean diameter, the fractal dimension of a contour, or coincidence with a plurality of predetermined model shapes)
The average density value of a morbid portion
The density distribution pattern of a morbid portion

Needless to say, various other image feature amounts can be calculated.

To calculate an image feature amount concerning a morbid portion, the range (boundary) of the morbid portion needs to be specified in advance. General methods of specifying the range of a morbid portion are a method (manual extraction method) of designating the boundary of a morbid portion by a doctor while seeing an image, and an automatic extraction method using an image processing technique. In the embodiment, either of manual extraction and automatic extraction is available. A combination of image feature amounts expressing F is important for calculating the similarity of image data. Generally, a larger number of image feature amounts can be used to express the feature of image data in more detail, but it takes a long similarity calculation time. Hence, F is normally defined as a combination of ten to several tens of image feature amounts which are less correlated in information.

A case data table 1000 is another example of the case data table having components different from those of the case data table 900. Note that a “case data ID (DID)”, “definite diagnosis name”, and “diagnosis group ID (GID)” are the same as those in the case data table 900.

“Predetermined clinical information C” is necessary clinical information selectively copied from medical record data archived in the medical record database 4. C is multi-dimensional information (vector information) formed from pieces of clinical information c1, c2, c3, . . . . Examples of the pieces of clinical information are various test values (e.g., physical examination value, blood test value, and test values regarding a specific disease such as a cancer marker and inflammatory marker), a past history, and a treatment history. A combination of pieces of clinical information expressing C is important for calculating the similarity of clinical information. Deciding a proper C greatly depends mainly on an organ to be diagnosed and the type of disease.

An “imaging date”, “image type”, and “target organ” are the same as those in the case data table 900. “Image data I of the region of interest” is a copy of image data in the region of interest in the slice image of interest selected from image data archived in the medical image database 3. I is multi-dimensional information (vector information) formed from pieces of pixel information i1, i2, i3, . . . as many as pixels falling within the region of interest. “Image feature information F of the region of interest” is the same as that in the case data table 900.

A main difference between the case data tables 900 and 1000 is whether to store reference information to the clinical information C and that to the image data I indirectly (the case data table 900) or directly (the case data table 1000). When the case database 2 has a sufficiently large capacity, it is preferable to directly store all data in the case data table, as exemplified by the case data table 1000. This is because data archived in one database are read out by only one data readout processing. Readout of data archived in a plurality of databases requires a plurality of data readout processes. This complicates the processing procedures and prolongs the processing time.

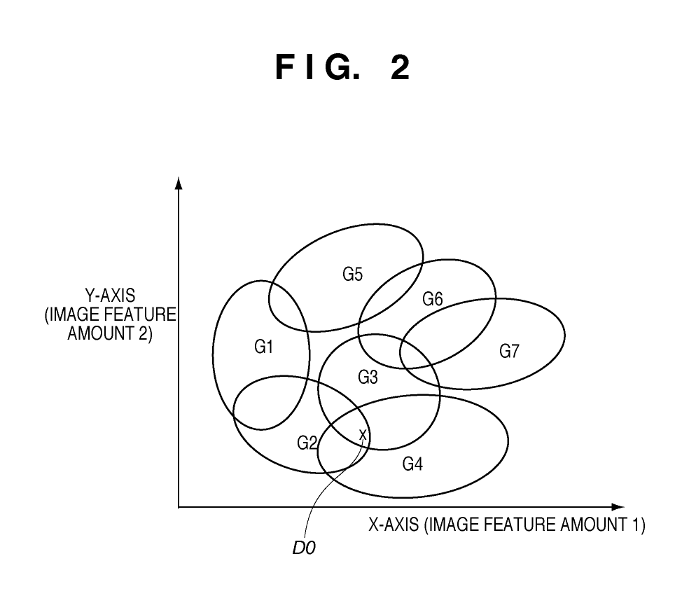

FIG. 2 is a view showing a conceptual relationship between the image feature amount of the region of interest and the diagnosis group in similar case search. In FIG. 2, the image feature information F of the region of interest is assumed to be defined by image feature amount 1 (f1) and image feature amount 2 (f2). Although F is generally defined by ten to several tens of image features, an image feature space (multi-dimensional vector space) given by F is represented by a two-dimensional X-Y coordinate space for illustrative convenience. In FIG. 2, the range of diagnosis groups is indicated by only the image feature information F. However, case data also includes the predetermined clinical information C, so the range of diagnosis groups may be represented by a multi-dimensional higher-order vector space using both the image feature information F and predetermined clinical information C. In this case, the similarity between indefinite case data and definite diagnosis name-attached case data is defined using both the image feature information F and predetermined clinical information C.

Referring to FIG. 2, diagnosis groups G1 to G7 each represented by an ellipse exist in the image feature space (X-Y coordinate space). The boundary of each diagnosis group indicates (the limit of) a range where case data belonging to each diagnosis group are distributed. There is a range where a plurality of diagnosis groups partially overlap each other because even diseases of different types belonging to different diagnosis groups sometimes have pieces of image feature information very similar to each other.

In FIG. 2, indefinite case data D0 is assumed to have image feature information F0 corresponding to a position “x”. At this time, the indefinite case data D0 is highly likely to belong to the diagnosis group G2, G3, or G4. As a similar case search result, a plurality of definite diagnosis name-attached case data belonging to at least the diagnosis groups G2, G3, and G4 are expected to be displayed.

<Operation of Apparatus>

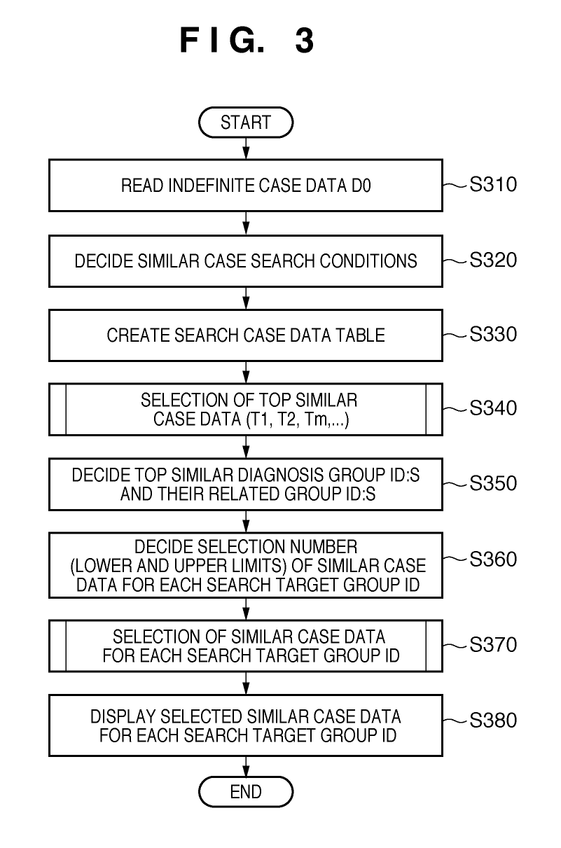

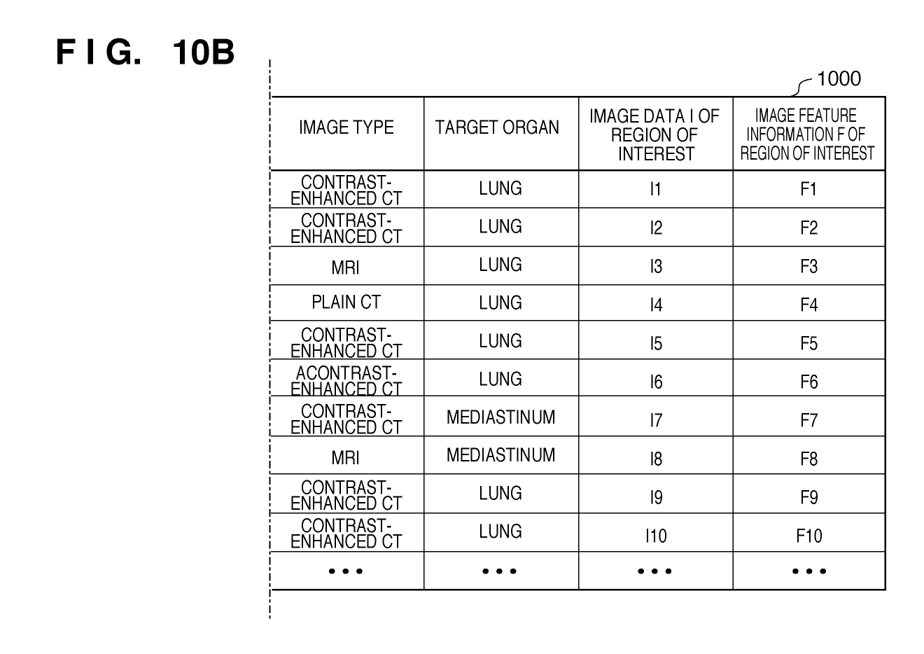

Control of the similar case search apparatus 1 by the controller 10 will be explained with reference to the flowcharts of FIGS. 3 to 5 and the data tables of FIGS. 11 to 17. The CPU 100 implements processes shown in the following flowcharts by executing programs stored in the main memory 101. Assume that a doctor operates the mouse 105 and keyboard 106 to input a variety of commands (instructions and orders) to the similar case search apparatus 1.

The execution status and execution result of a program executed by the CPU 100 are displayed on the monitor 104 as a result of the function of the OS and display program separately executed by the CPU 100. The case database 2 is assumed to archive the case data table 1000 exemplified in FIGS. 10A and 10B.

FIG. 3 is a flowchart of processing by the similar case search apparatus according to the first embodiment.

In step S310, the CPU 100 accepts input of indefinite case data D0 in response to a command input from a user (doctor). More specifically, the CPU 100 reads the indefinite case data D0 into the main memory 101 from the medical image database 3 or a medical imaging apparatus (not shown) via the shared bus 107 and LAN 5. The CPU 100 may read the indefinite case data D0 into the main memory 101 via the magnetic disk 102 or an external storage device (not shown) via the shared bus 107. In the following description, the indefinite case data D0 includes only information on image data for descriptive convenience. That is, the indefinite case data D0 includes the imaging date, image type, target organ, image data I0 of the region of interest, and image feature information F0 of the region of interest, but does not include predetermined clinical information C0. Similar case search processing is therefore almost the same as similar image search processing. Note that the indefinite case data D0 may include the predetermined clinical information C0 obtained from various clinical test results and the like. Basic processing procedures are the same between a case in which the indefinite case data D0 includes the predetermined clinical information C0 and a case in which the indefinite case data D0 does not include it, except for whether or not to use C0 in similarity calculation.

In step S320, the CPU 100 decides similar case search conditions in accordance with the command input from the doctor. The similar case search conditions are used to limit case data to undergo similar case search. More specifically, only case data whose “image type” and “target organ” components match those of the indefinite case data D0 are subjected to similar case search. This is because when these components are different from those of the indefinite case data D0, the image feature information F of the region of interest is often greatly different. Thus, it is good for working efficiency to exclude, from search targets from the beginning, case data whose components mentioned above differ from those of the indefinite case data D0. It is preferable that decided similar case search conditions can be flexibly changed in accordance with a command input from a doctor in preparation for similar case search from case data different in “image type” and/or “target organ”.

In the following processing example, the “image type” of the indefinite case data D0 is a “contrast-enhanced CT image” and the “target organ” is the “lung”. That is, a processing example upon receiving a command to set the “contrast-enhanced CT image” as the “image type” and the “lung” as the “target organ” as similar case search conditions will be explained.

In step S330, the CPU 100 creates a search case data table exemplified in FIG. 11 in the main memory 101 under the similar case search conditions decided in step S320. At this time, if the main memory 101 does not have sufficient free space, the CPU 100 may perform control to create a search case data table in the magnetic disk 102 and read out only data necessary for processing (to be described later) into the main memory 101. The method of creating a search case data table will be described later.

FIG. 11 exemplifies the search case data table. A “second case data ID (D′ID)” is an identifier for uniquely identifying case data in the search case data table. As D′IDs, sequential numbers are assigned in order from the first row after the end of sorting the search case data table (to be described later). “Case data ID (DID)”, “diagnosis group ID (GID)”, and “image feature information F of the region of interest” are the same as those described with reference to the case data tables 900 and 1000. “Similarity R” means the similarity between the indefinite case data D0 and case data D′1, D′2, D′3, . . . in the search case data table. At the time of step S330, the similarity R has not yet been calculated.

The search case data table creation method will be described in detail. The CPU 100 reads case data meeting similar case search conditions from the case database 2 via the shared bus 107 and LAN 5. As described in step S320, case data are limited to those whose “image type” and “target organ” are a contrast-enhanced CT image and lung, respectively, as the similar case search conditions in the embodiment. In FIG. 11, only case data whose “image type” and “target organ” are a contrast-enhanced CT image and lung, respectively, are read out among case data in the case data table 1000. To reduce unnecessary data transfer, the CPU 100 reads only components (“case data ID (DID)”, “diagnosis group ID (GID)”, and “image feature information F of the region of interest”) necessary for the search case data table. A value “0” is substituted as an initial value into the “similarity R”. After reading the case data, the CPU 100 sorts the rows of the search case data table based on the diagnosis group ID (GID) in order to increase the processing speed in step S370 (to be described later). FIG. 11 exemplifies the result of sorting rows in ascending order of the diagnosis group ID (GID). After sorting the search case data table, sequential numbers are assigned in the “second case data ID (D′ID)” in order from the first row.

In the first embodiment, as a notation representing row data in an arbitrary table, when a value (an ID in general) written at the start of a row (first column) is a value X, all row data are denoted by X. In other words, X={X, . . . } In the example of FIG. 11, D′1 represents case data on the first row, D′2 represents those on the second row, and D′n represents those on the nth row. The same notation also applies to other tables.

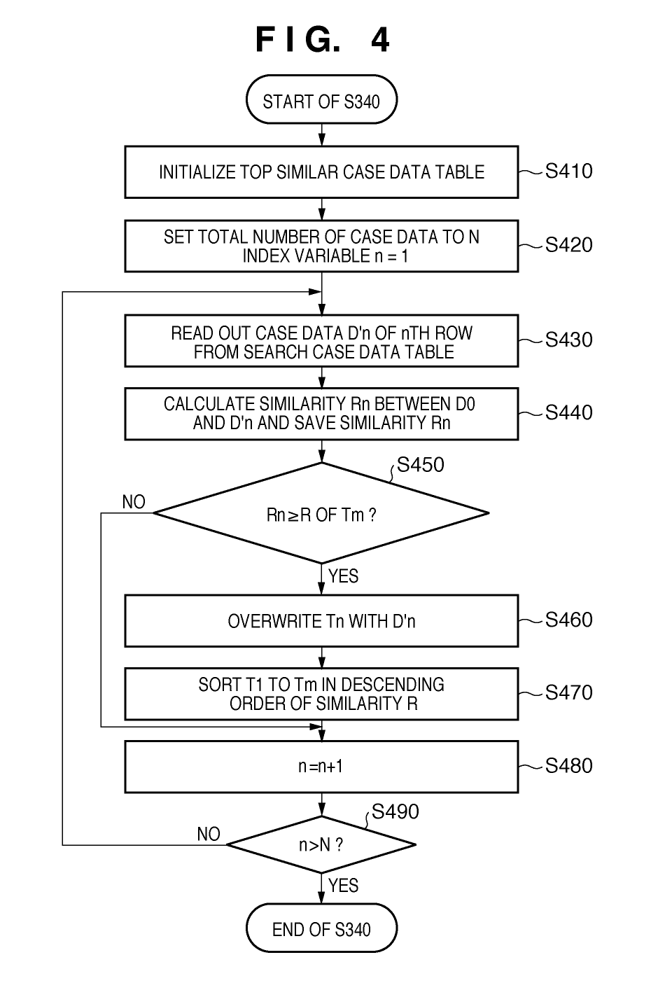

In step S340, the CPU 100 selects top similar case data T1, T2, . . . , Tm from the search case data table exemplified in FIG. 11. The top similar case data mean the first to mth case data T1, T2, . . . , Tm when all case data in the search case data table are sorted in descending order of similarity with the indefinite case data D0. The value m (number of top similar case data) needs to be set in advance. The initial value m is written in advance in the read only memory or nonvolatile memory (not shown) of the controller 10. The value m can be changed by writing it in the nonvolatile memory (not shown) by the CPU 100 in accordance with a command input from the doctor. Detailed processing procedures in step S340 will be described with reference to FIGS. 4, 11, and 12.

FIG. 12 is a table exemplifying a top similar case data table created by executing step S340 for the search case data table exemplified in FIG. 11. The top similar case data table is obtained by storing the top similar case data selected in step S340 by the CPU 100 in the form of a table in the main memory 101. In the example of FIG. 12, the value m (number of top similar case data) is set to “3”. For this reason, the top similar case data table in FIG. 12 is formed from three rows T1, T2, and T3.

A “top similar case data ID (TID)” is an identifier for uniquely identifying top similar case data. After the end of selecting top similar case data in step S340, sequential numbers are assigned as TIDs in order from the first row. A “second case data ID (D′ID)”, “diagnosis group ID (GID)”, and “similarity R” are the same as those described with reference to FIG. 11, and are copied from the search case data table (FIG. 11). In the example of FIG. 12, case data D′S, D′3, and D′6 in the case data of FIG. 11 are selected as top similar case data. The rows of the table in FIG. 12 are sorted in descending order of the “similarity R” value, so the value R5≧the value R3≧the value R6.

FIG. 4 is a flowchart showing the detailed processing procedures of step S340.

In step S410, the CPU 100 creates a top similar case data table exemplified in FIG. 12 in the main memory 101, and initializes all the components of the top similar case data table to a value “0”. In the example of FIG. 12, the value m=3. Thus, the CPU 100 creates a top similar case data table having three rows, and substitutes a value “0” into all components.

In step S420, the CPU 100 checks a value N representing the total number of case data (number of rows of the search case data table) in the search case data table exemplified in FIG. 11, and stores the value N in the main memory 101. The CPU 100 substitutes an initial value “1” into an index variable n representing the row of interest in the search case data table exemplified in FIG. 11, and stores the index variable n in the main memory 101.

In step S430, the CPU 100 reads out case data D′n of the nth row from the search case data table exemplified in FIG. 11.

In step S440, the CPU 100 calculates a similarity Rn between the indefinite case data D0 read in step S310 and the case data D′n read out in step S430. The CPU 100 stores the similarity Rn by writing it in the “similarity R” column of the nth row in the search case data table stored in the main memory 101. As the method of calculating the similarity Rn, an arbitrary calculation method can be defined as long as it uses information included in both the indefinite case data D0 and case data D′n. In the example of FIG. 11, the “image feature information F of the region of interest” (F={f1, f2, f3, . . . }) can be used to calculate the similarity Rn. Equation (1) is an example of the calculation equation of the similarity Rn between image feature information F0 of the region of interest in the indefinite case data D0 and image feature information Fn of the region of interest in the case data D′n. Note that the calculation method of the similarity Rn is not limited to equation (1).

$$[ Equation 1 ] \begin{matrix}\begin{matrix} Rn = \frac{1}{\sqrt{{( Fn - F 0 )}^{2}}} \\ = \frac{1}{\sqrt{{( fn 1 - f 01 )}^{2} + {( fn 2 - f 02 )}^{2} + {( fn 3 - f 03 )}^{2} + …}} \end{matrix} & ( 1 )\end{matrix}$$

where F0={f01, f02, f03, . . . } and Fn={fn1, fn2, fn3, . . . }

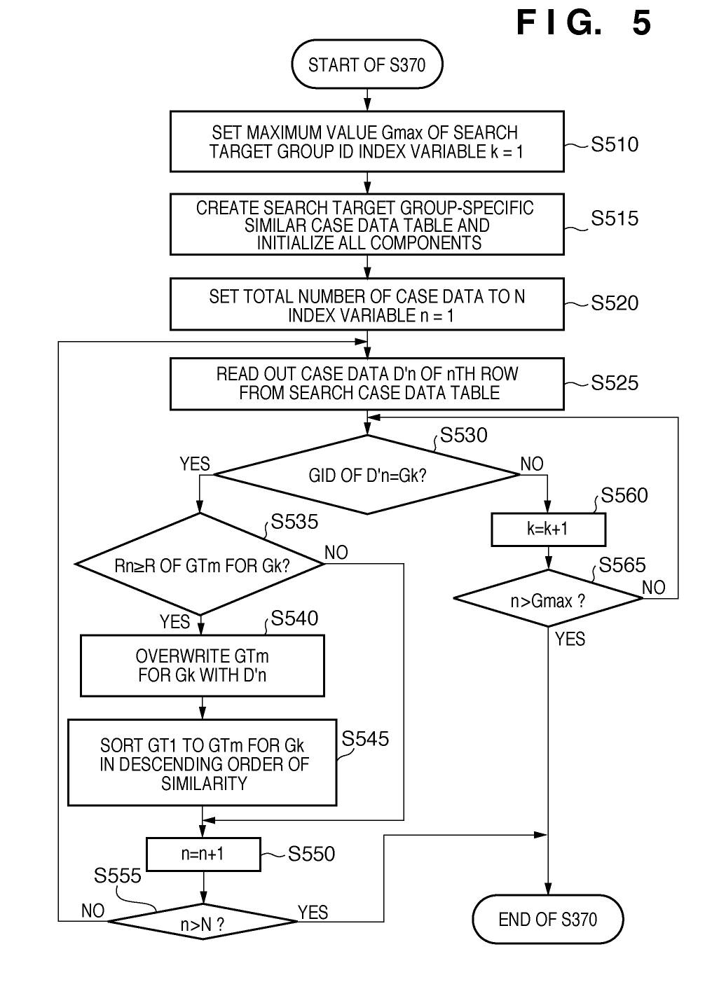

Equation (1) can be geometrically represented as a reciprocal of the Euclidean distance between the F0 and Fn vectors. The similarity Rn should take a larger value for a longer distance between the vectors and thus is defined as a reciprocal of the distance between the vectors. To reduce the calculation amount, a difference R′n may be calculated based on equation (2), in place of the similarity Rn. To further reduce the calculation amount, a difference R″n may be calculated based on equation (3). When the difference R′n or R″n is calculated instead of the similarity Rn, a determination method in step S450 is also changed, which will be described later. A determination method in step S535 of FIG. 5 is also changed similarly to that in step S450, a description of which will be omitted.

$$[ Equation 2 ]$$

$$\begin{matrix} \begin{matrix}{R}^{′} n = {( Fn - F 0 )}^{2} \\ = {( fn 1 - f 01 )}^{2} + {( fn 2 - f 02 )}^{2} + {( fn 3 - f 03 )}^{2} + …\end{matrix} \\ [ Equation 3 ] & ( 2 ) \\ \begin{matrix}{R}^{″} n = \vert Fn - F 0 \vert \\ = \vert fn 1 - f 01 \vert + \vert fn 2 - f 02 \vert + \vert fn 3 - f 03 \vert + …\end{matrix} & ( 3 )\end{matrix}$$

In step S450, the CPU 100 compares the similarity Rn calculated in step S440 with the similarity R of top similar case data Tm (T3 in the example of FIG. 12) on the final row in the top similar case data table. If the value Rn is greater than or equal to the value R of Tm, top similar case data need to be replaced, and the process advances to step S460. If the value Rn is smaller than the value R of Tm, no top similar case data need be replaced, and the process advances to step S480.

When the difference R′n or R″n is calculated in place of the similarity Rn in step S440, the determination method in step S450 is changed as follows. If the value R′n or R″n is smaller than the value R′ or R″ of Tm, top similar case data must be replaced, and the process advances to step S460. If the value R′n or R″n is greater than or equal to the value R′ or R″ of Tm, no top similar case data need be replaced, and the process advances to step S480.

In step S460, the CPU 100 overwrites the row Tm (T3 in the example of FIG. 12) of the top similar case data with three components of the case data D′n read out in step S430. The three components are the value D′n of the “second case data ID (D′ID)”, the value of “diagnosis group ID (GID)”, and that of the “similarity R”.

In step S470, the CPU 100 sorts all the rows (from T1 to Tm) of the top similar case data table in descending order of the “similarity R” value.

In step S480, the CPU 100 increments the index variable n (by one).

In step S490, the CPU 100 compares the index variable n with the number N of rows of the search case data table. If the value n is larger than the value N, all the case data in the search case data table have already been read, and the processing in step S340 ends. If the value n is less than or equal to the value N, not all the case data in the search case data table have been read yet, and the process returns to step S430 and continues. As described above, the contents of the top similar case data table (FIG. 12) are obtained by executing step S340 for the contents of the search case data table (FIG. 11).

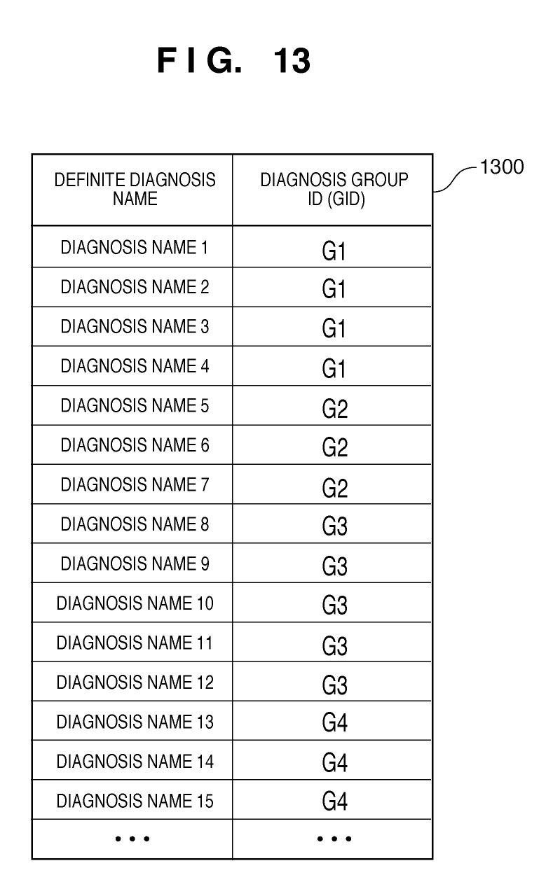

In step S350, the CPU 100 checks top similarity diagnosis group IDs and their related group IDs, and decides a combination of each top similarity diagnosis group ID and its related group IDs as a search target group ID. Processing procedures at this time will be described in detail with reference to FIGS. 12 and 14.

The CPU 100 checks values on all rows in the “diagnosis group ID (GID)” column of the top similar case data table exemplified in FIG. 12. The CPU 100 stores all detected GID values (values G3 and G4 in the example of FIG. 12) as top similar diagnosis group IDs in the main memory 101. Then, the CPU 100 checks all group IDs related to the top similar diagnosis group IDs by referring to a correspondence table between the “diagnosis group ID (GID)” and a plurality of “related group IDs” exemplified in FIG. 14. The CPU 100 stores all the related group IDs in the main memory 101. At this time, the CPU 100 discriminately stores a group ID (overlapping related group ID) related to a plurality of top similar diagnosis group IDs, and a group ID (single related group ID) related to only one top similar diagnosis group ID.

In the examples of FIGS. 12 and 14, a value G2 serving as a group ID related to both values G3 and G4 serving as top similar diagnosis group IDs is an overlapping related group ID. Values G6 and G7 serving as group IDs related to only the value G3 are single related group ID. In processing to be described later, the CPU 100 processes a combination of each top similar diagnosis group ID and its related group IDs as a search target group ID. The example of FIG. 14 corresponds to the relationship between diagnosis groups exemplified in FIG. 2. More specifically, in FIG. 2, G1 is distributed in a range where it overlaps G2 and G5. In FIG. 14, the related group ID={value G2, value G5} for the diagnosis group ID=value G1.

In step S360, the CPU 100 decides the lower and upper limits of the selection number of similar case data for each search target group ID. That is, the CPU 100 sets an extraction criterion for each group.

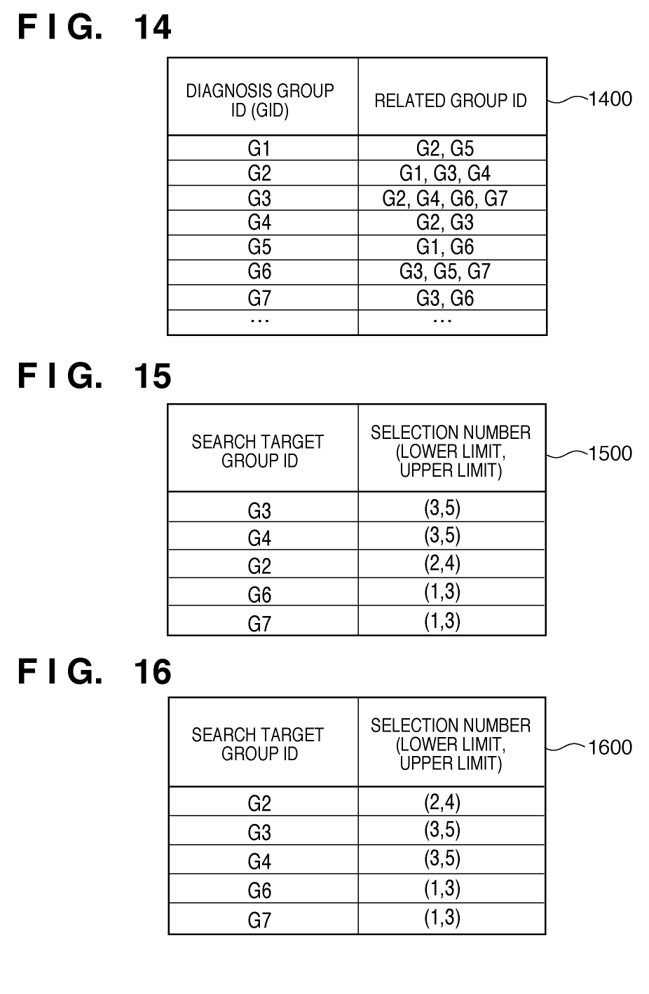

FIG. 15 exemplifies a correspondence table between the “search target group ID” and the “selection number (lower limit, upper limit)” of similar case data. The contents exemplified in FIG. 15 correspond to those exemplified in FIGS. 12 and 14. First, the CPU 100 checks the total number of search target group IDs (top similar diagnosis group IDs and their related group IDs) stored in the main memory in step S350, and creates a correspondence table exemplified in FIG. 15 having rows corresponding to the total number. Then, the CPU 100 writes top similar diagnosis group IDs (values G3 and G4), overlapping related group ID (value G2), and single related group IDs (values G6 and G7) sequentially from the first row in the “search target group ID” column of the correspondence table exemplified in FIG. 15. Further, the CPU 100 writes the lower and upper limits of the selection number of similar case data in the “selection number (lower limit, upper limit)” column of the correspondence table exemplified in FIG. 15 under the following rules.

How to decide the selection number (lower limit, upper limit) will be explained with reference to FIG. 15. As a basic idea, selection numbers (lower limit, upper limit) use values set in advance for each of a top similar diagnosis group ID, overlapping related group ID, and single related group ID. The example of FIG. 15 is calculated under the following rules:
A predetermined lower limit (value “3”) of the selection number is used for the top similar diagnosis group IDs (G3 and G4).
A value (value “2”) smaller by one than the lower limit of the selection number of the top similar diagnosis group ID is used as the lower limit of the selection number for the overlapping related group ID (G2).
A value (value “1”) smaller by one than the lower limit of the selection number of the overlapping related group ID is used as the lower limit of the selection number for the single related group IDs (G6 and G7).
A value calculated by adding 2 to the lower limit is used as the upper limit of each selection number.

By applying these rules, only the first value suffices to be decided in advance. When the predetermined value is set to be changeable in accordance with a command input from a doctor, the number of similar cases displayed as similar case search results can be changed. In addition to this decision method, the selection number (lower limit, upper limit) can be decided in various ways. A preferable decision method changes depending on the preference of a user, that is, doctor, the window size for displaying similar case search results, and the like. It is also possible to prepare in advance a plurality of selection number (lower limit, upper limit) decision methods and change the selection number (lower limit, upper limit) decision method based on a command input from a doctor.

In the first embodiment, the lower and upper limits of the selection number of similar case data are decided, but both of them need not always be decided. For example, only one selection number may be decided for each search target group ID, instead of flexibly setting the selection number of similar case data. In this case, deciding each selection number means setting the lower and upper limits of the selection number to be equal to each other. Processing procedures when deciding each selection number fall within those when deciding the lower and upper limits of the selection number.

In step S370, the CPU 100 selects similar case data for each search target group ID. Detailed processing procedures in step S370 will be described with reference to FIGS. 5, 16, and 17.

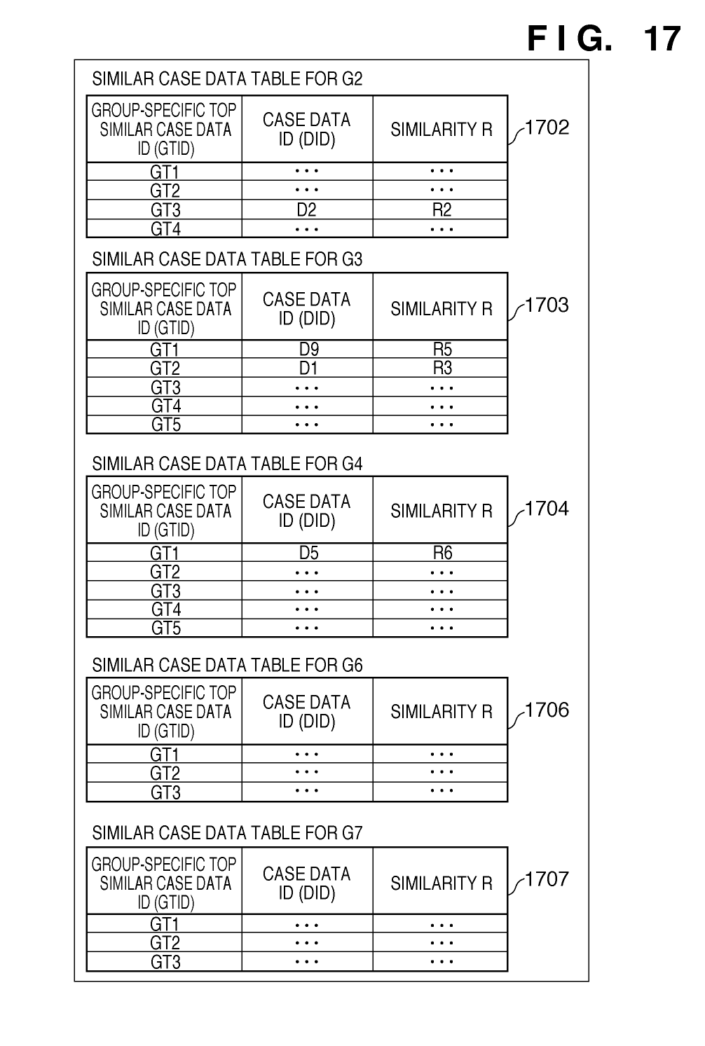

FIG. 16 exemplifies a table obtained by sorting the correspondence table between the “search target group ID” and the “selection number (lower limit, upper limit)” of similar case data exemplified in FIG. 15 in ascending order of the “search target group ID”. Sorting can simplify the detailed processing procedures in step S370 to be described below.

FIG. 17 exemplifies a search target group-specific similar case data table. In the example of FIG. 16, there are five search target groups G2, G3, G4, G6, and G7. In the example of FIG. 17, therefore, similar case data tables for G2, G3, G4, G6, and G7 are created.

FIG. 5 is a flowchart of details of step S370.

In step S510, the CPU 100 checks the value of a “search target group ID” on the final row of the correspondence table exemplified in FIG. 16, and stores this value in the main memory 101 as a maximum value Gmax of the “search target group ID”. The CPU 100 substitutes an initial value “1” into an index variable k representing the row of interest in the sorted correspondence table exemplified in FIG. 16, and stores the value k in the main memory 101.

In step S515, the CPU 100 creates search target group-specific similar case data tables exemplified in FIG. 17 in the main memory 101 by referring to the correspondence table exemplified in FIG. 16. Then, the CPU 100 initializes all the components of all the tables to a value “0”. Procedures to create search target group-specific similar case data tables will be explained in detail with reference to the examples of FIGS. 16 and 17.

The CPU 100 processes the respective rows in FIG. 16 one by one, creating a similar case data table for each search target group. First, the CPU 100 reads out the value G2 of the “search target group ID” and the values (2, 4) of the “selection number (lower limit, upper limit)” on the first row. The CPU 100 creates a similar case data table for G2 having rows (four rows) equal in number to the upper limit of the selection number, and initializes all the components of the table to a value “0”. The CPU 100 processes the second and subsequent rows in FIG. 16 in the same way, creating search target group-specific similar case data tables exemplified in FIG. 17.

In step S520, the CPU 100 checks the total number N of case data (number of rows of the search case data table) in the search case data table exemplified in FIG. 11, and stores the value N in the main memory 101. Note that the value N has already been stored in the main memory 101 in step S420 of FIG. 4. If the value N remains stored even after the end of the processing in FIG. 4 (processing in step S340), it need not be stored again in step S520. Then, the CPU 100 substitutes an initial value “1” into the index variable n representing the row of interest in the search case data table exemplified in FIG. 11, and stores the value n in the main memory 101.

In step S525, the CPU 100 reads out case data D′n of the nth row from the search case data table exemplified in FIG. 11.

In step S530, the CPU 100 compares the value of the diagnosis group ID (GID) in the case data D′n read out in step S525 with a value Gk to be described below. If the two values are equal to each other as a result of the comparison, the process advances to step S535. If the two values are different from each other as a result of the comparison, the process advances to step S560.

How to obtain the value Gk will be explained in detail with reference to the tables shown in FIGS. 16 and 17. The suffix k of the value Gk is the index variable k mentioned in step S510. Gk is the value of a “search target group ID” on the kth row in FIG. 16. As shown in FIG. 16, Gk=G2 for k=1, Gk=3 for k=2, Gk=4 for k=3, Gk=6 for k=4, and Gk=7 for k=5.

When step S530 is executed for the first time, case data D′1 on the first row in FIG. 11 is read out, so GID of D′1=value G1. The index variable k=1 at the beginning, so Gk=G2. Since G1≠G2, the process advances to step S560 after executing step S530 for the first time. The process advances to step S535 only when the value of a diagnosis group ID (GID) of case data among case data exemplified in FIG. 11 matches the value of any search target group ID exemplified in FIG. 16. Only case data belonging to the search target group can be subjected to similar case search.

In step S535, the CPU 100 compares two “similarity R” values. One “similarity R” value is the value Rn of the “similarity R” in the case data D′n read out in step S525. The other “similarity R” value is the value (to be simply referred to as an R value of GTm for Gk) of the “similarity R” on a final row GTm of a similar case data table for Gk exemplified in FIG. 17. If the value Rn is greater than or equal to the R value of GTm for Gk, the contents of the similar case data table for Gk need to be updated, and the process advances to step S540. If the value Rn is smaller than the R value of GTm for Gk, the process advances to step S550.

In step S540, the CPU 100 overwrites the final row GTm of the similar case data table for Gk exemplified in FIG. 17 with the value Dn of the “case data ID (DID)” of the case data D′n read out in step S525 and the value Rn of the “similarity R”.

In step S545, the CPU 100 sorts all the rows (from GT1 to GTm) of the similar case data table for Gk in ascending order of the “similarity R”. As a result, the “similarity R” of GTm is the smallest value in the similar case data table for Gk.

In step S550, the CPU 100 increments the index variable n by one. In step S555, the CPU 100 compares the index variable n with the value N (number of rows of the search case data table exemplified in FIG. 11). If the index variable n is larger than the value N, the processing in step S370 ends. If the index variable n is less than or equal to the value N, the process returns to step S525 and continues.

In step S560, the CPU 100 increments the index variable k by one. In step S565, the CPU 100 compares the index variable k with the value Gmax (value of the “search target group ID” on the final row of the correspondence table exemplified in FIG. 16: Gmax=G7 in the example of FIG. 16). If the index variable k is larger than the value Gmax, the processing in step S370 ends. If the index variable k is less than or equal to the value Gmax, the process returns to step S530 and continues.

By the processing in step S370 described with reference to FIG. 5, a similar case data table for each search target group (=each diagnosis group) exemplified in FIG. 17 is completed.

In the processing procedures of the step S370 described with reference to FIG. 5, definite case data are arranged in descending order of similarity and a predetermined number of definite case data are selected from the top, instead of selecting similar case data by simply performing threshold processing between indefinite case data and definite case data. The following problem arises when similar case data are selected by simply executing threshold processing of similarity. More specifically, if the number of case data archived in the case database 2 increases, the number of case data highly similar to each other rises. Hence, the number of selected similar case data increases unless the threshold of similarity is changed. In similar case search by threshold processing of similarity, similar case search results vary depending on the number of case data archived in the case database 2. To the contrary, the processing procedures in the first embodiment are not affected by size variations of the case database 2 and have an advantage capable of always searching for a predetermined number of diagnosis group-specific similar case data.

In step S380, the CPU 100 classifies similar case data into respective diagnosis groups and displays them by referring to the contents of diagnosis group-specific similar case data tables created in step S370. Processing procedures when reading out similar case data for each search target group by the CPU 100 will be described in detail with reference to the examples of FIGS. 15 and 17.

The CPU 100 reads out values in the “search target group ID” of the correspondence table exemplified in FIG. 15 sequentially from the first row. The CPU 100 selects a similar case data table corresponding to the readout value of the “search target group ID” from the search target group-specific similar case data tables exemplified in FIG. 17. More specifically, the CPU 100 first reads out the value G3 from the first row of the correspondence table in FIG. 15, and selects the similar case data table for G3 in FIG. 17.

Then, the CPU 100 reads out values in the “case data ID (DID)” of the similar case data table for G3 in FIG. 17 sequentially from the first row. The CPU 100 reads out case data corresponding to the readout DID value from the case data table exemplified in FIGS. 9A and 9B or FIGS. 10A and 10B. More specifically, the CPU 100 reads out the DID value G9 from the first row of the similar case data table for G3 in FIG. 17. The CPU 100 also reads out case data D9 having the DID value D9 (=ninth row) from the case data table 900 or case data table 1000.

When D9 is read out from the case data table 1000, a “definite diagnosis name”, “predetermined clinical information C”, and “image data I of the region of interest” in D9 are extracted, obtaining the first definite diagnosis name-attached similar case data for G3. Other definite diagnosis name-attached similar case data can also be attained by the same procedures.

When D9 is read out from the case data table 900, a “definite diagnosis name” can be directly extracted, but predetermined clinical information and image data of the region of interest need to be read out from the medical record database 4 and medical image database 3, respectively. To extract predetermined clinical information, “reference information to medical record data” in D9 read out from the case data table 900 is extracted. Then, medical record data referred to by the reference information is read out from the medical record database 4. Predetermined clinical information is extracted from the medical record data. To extract image data of the region of interest, “reference information to image data” in D9 read out from the case data table 900 is extracted. Then, image data referred to by the reference information is read out from the medical image database 3. Further, a “slice number of interest” and “coordinate information (X0, Y0, X1, Y1) of the region of interest” in D9 read out from the case data table 900 are extracted. By using these pieces of information, the slice number of interest and the region of interest in the image data read out from the medical image database 3 are specified, obtaining image data of the region of interest.

Consequently in the examples of FIGS. 15 and 17, definite diagnosis name-attached similar case data of five cases, five cases, four cases, three cases, and three cases are obtained for the search target groups G3, G4, G2, G6, and G7, respectively. That is, a predetermined number or more of similar definite case data are extracted from each group.

When reducing the number of definite diagnosis name-attached similar case data owing to, for example, a small window size for displaying similar case search results, the selection number of similar case data for each search target group (=diagnosis group) is decreased. At this time, the selection number of similar case data for each search target group (=diagnosis group) can be decreased up to the lower limit 1) by referring to the lower limit of the selection number of similar case data exemplified in FIG. 15.

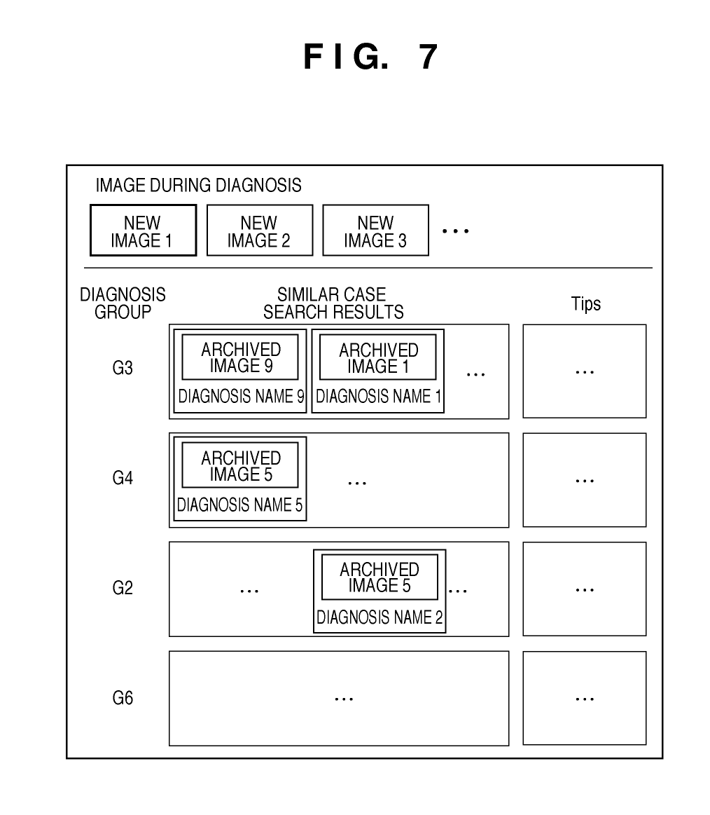

FIG. 7 exemplifies a window displayed as a result of the processing in step S380. Some of image data during diagnosis are displayed at the first stage of FIG. 7. These images are obtained by extracting regions of interest by a doctor from the image data during diagnosis. For example, “new image 1” may be an image attained by extracting a region of interest containing an abnormal shadow captured in part of the lung field of a chest CT image. When the doctor selects the image “new image 1” and inputs a command to execute similar case search, similar case search results are displayed at a portion below the boundary in the window as a result of the processing. This window example displays diagnosis group names, definite diagnosis name-attached similar case data (=similar image data) arranged in descending order of similarity for each diagnosis group (=search target group), and tips (directions for diagnosis) for each diagnosis group.

As described above, the similar case search apparatus according to the first embodiment can extract a plurality of definite case data having different diagnosis results from the case database 2 for input indefinite case data. Based on the diagnosis results of the extracted definite case data, a user (doctor) can examine a plurality of diagnosis results which may correspond to the input case data.

### Second Embodiment

The second embodiment will explain a technique of extracting various kinds of definite case data as compared to the first embodiment. The apparatus arrangement is the same as that in the first embodiment, and a description thereof will not be repeated. The processing procedures described with reference to the flowcharts of FIGS. 3 and 4 are also the same, and a description thereof will not be repeated. The second embodiment is mainly different in some of the detailed procedures of S370 in the first embodiment.

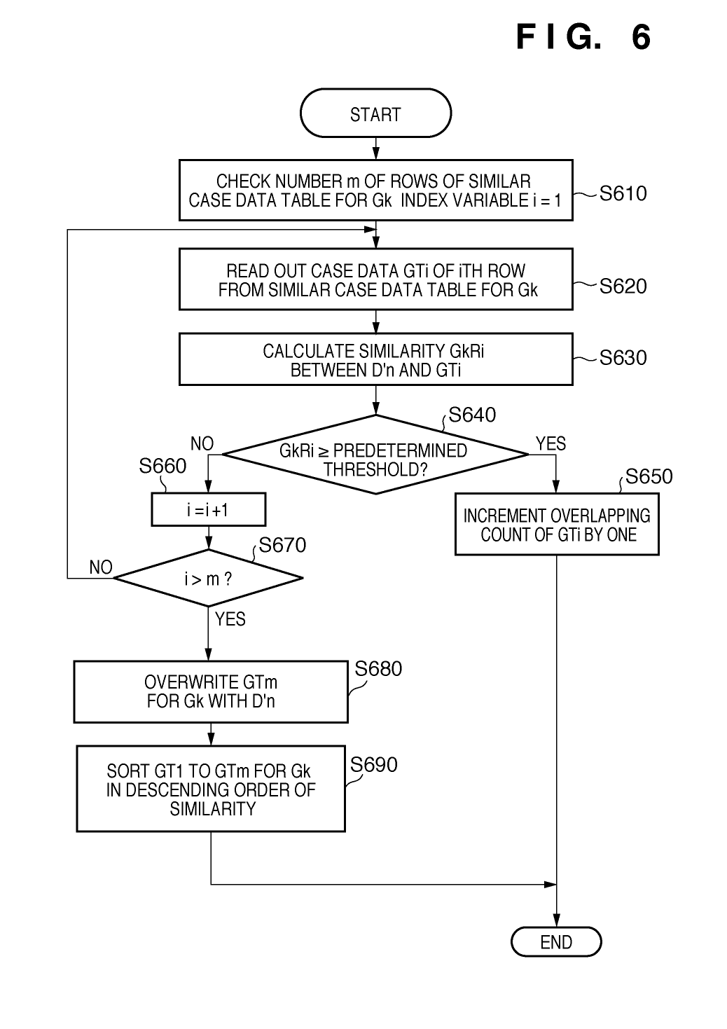

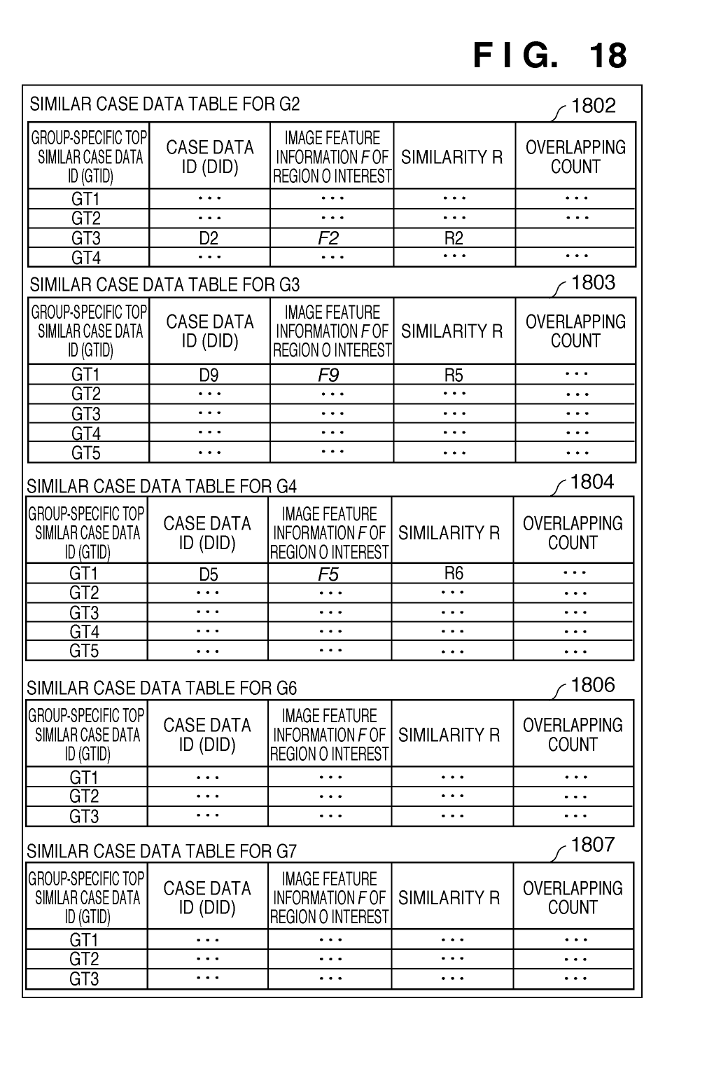

Processing procedures in S370 according to the second embodiment will be explained with reference to the flowcharts of FIGS. 5 and 6 and a data table shown in FIG. 18.

Processing in step S510 is the same as that in the first embodiment. Processing in step S515 is almost the same as that in the first embodiment except that a search target group-specific similar case data table exemplified in FIG. 18 is created in place of the search target group-specific similar case data table exemplified in FIG. 17.

FIG. 18 shows another example of the search target group-specific similar case data table. A similar case data table for Gk exemplified in FIG. 18 is created by adding pieces of information of the following two columns to the similar case data table for Gk exemplified in FIG. 17. The first added column is “image feature information F of the region of interest”, and the second one is “overlapping count”.

In step S515, a CPU 100 creates search target group-specific similar case data tables exemplified in FIG. 18 in a main memory 101, and initializes all the components of all the tables to a value “0”.

Processes in steps S520 to S535 and steps S550 to S565 are the same as those in the first embodiment, and a description thereof will not be repeated.

The processing in the second embodiment is greatly different from that in the first embodiment in steps S540 and S550 of FIG. 5. According to the processing procedures in the second embodiment, steps S540 and S545 in FIG. 5 are not executed, but steps S610 to S690 shown in the flowchart of FIG. 6 are executed instead.

FIG. 6 is a flowchart showing processing procedures according to the second embodiment.

In step S610, the CPU 100 checks the number m of rows of the similar case data table for Gk exemplified in FIG. 18, and stores the value m in the main memory 101. The CPU 100 substitutes an initial value “1” into an index variable i representing the row of interest in the similar case data table for Gk exemplified in FIG. 18, and stores the index variable i in the main memory 101. Gk of the similar case data table for Gk is the value of the “search target group ID” exemplified in FIG. 16. The suffix k of Gk is an index variable representing the row of interest in a sorted correspondence table exemplified in FIG. 16, as described in step S510 of FIG. 5.

In step S620, the CPU 100 reads out case data GTi of the ith row from the similar case data table for Gk exemplified in FIG. 18.

In step S630, the CPU 100 calculates a similarity GkRi between case data D′n read out in step S525 of FIG. 5 and GTi read out in step S620. The calculation method of the similarity GkRi is the same as that of the similarity Rn described in step S440 of FIG. 4. More specifically, letting Fn be image feature information of the region of interest of the case data D′n and Fi be that of the region of interest of the case data GTi, the similarity GkRi can be calculated based on equation (4):

$$[ Equation 4 ]$$

$$\begin{matrix}GkRi = \frac{1}{\sqrt{{( Fi - Fn )}^{2}}} \\ = \frac{1}{\sqrt{{( fi 1 - fn 1 )}^{2} + {( fi 2 - fn 2 )}^{2} + {( fi 3 - fn 3 )}^{2} + …}}\end{matrix} \qquad ( 4 )$$

where Fn={fn1, fn2, fn3, . . . } and Fi={fi1, fi2, fi3, . . . }

As described in step S440 of FIG. 4, a difference GkR′i or GkR″i may be calculated using equation (5) or (6), in place of the similarity GkRi. When the difference GkR′i or GkR″i is calculated instead of the similarity GkRi, a determination method in step S640 is also changed, which will be described later.

$$[ Equation 5 ]$$

$$\begin{matrix} \begin{matrix}{GkR}^{′} i = {( Fi - Fn )}^{2} \\ = {( fi 1 - fn 1 )}^{2} + {( fi 2 - fn 2 )}^{2} + {( fi 3 - fn 3 )}^{2} + …\end{matrix} \\ [ Equation 6 ] & ( 5 ) \\ \begin{matrix}{GkR}^{″} i = \vert Fi - Fn \vert \\ = \vert fi 1 - fn 1 \vert + \vert fi 2 - fn 2 \vert + \vert fi 3 - fn 3 \vert + …\end{matrix} & ( 6 )\end{matrix}$$

In step S640, the CPU 100 compares the similarity GkRi calculated in step S630 with a predetermined threshold. The predetermined threshold is used to determine whether two case data belonging to the same diagnosis group are very similar to each other. If the similarity GkRi is equal to or higher than the predetermined threshold (the case data D′n and GTi are very similar), the process advances to step S650. If the similarity GkRi is lower than the predetermined threshold (the case data D′n and GTi are not so similar), the process advances to step S660.

When the difference GkR′i or GkR″i is calculated in place of the similarity GkRi in step S630, the determination method in step S640 is changed as follows. If the difference GkR′i or GkR″i is smaller than a predetermined threshold, the process advances to step S650. If the difference GkR′i or GkR″i is greater than or equal to the predetermined threshold, the process advances to step S660.

In step S650, the CPU 100 increments the “overlapping count” of the case data GTi by one, and writes it in the “overlapping count” column of the ith row in the similar case data table for Gk exemplified in FIG. 18. After that, the processing in FIG. 6 ends. This processing selects only one of very similar case data belonging to the same diagnosis group (similar groups). The “overlapping count” is incremented to notify a user (doctor) of the number of similar case data which are not selected because they are very similar.

In step S660, the CPU 100 increments the index variable i by one. In step S670, the CPU 100 compares the index variable i with the value m checked in step S610. If i is greater than m, the process advances to step S680. If i is less than or equal to m, the process returns to step S620.

In step S680, the CPU 100 overwrites the final row GTm (GT4 in the example of the similar case data table for G2 in FIG. 18) of the similar case data table for Gk with three components of the case data D′n read out in step S525 of FIG. 5. This is because when the process reaches step S680, the CPU 100 has confirmed that similar case data very similar to the case data D′n read out in step S525 of FIG. 5 does not exist in the similar case data table for Gk exemplified in FIG. 18. The three overwritten components are the value Dn of the “case data ID (DID)”, the value Fn of the “image feature information F of the region of interest”, and the value Rn of the “similarity R”. At this time, an initial value “0” is written in the “overlapping count” of the final row GTm of the similar case data table for Gk.

In step S690, the CPU 100 sorts all the rows (from GT1 to GTm) of the similar case data table for Gk in descending order of the “similarity R” value. Thereafter, the processing in FIG. 6 ends.

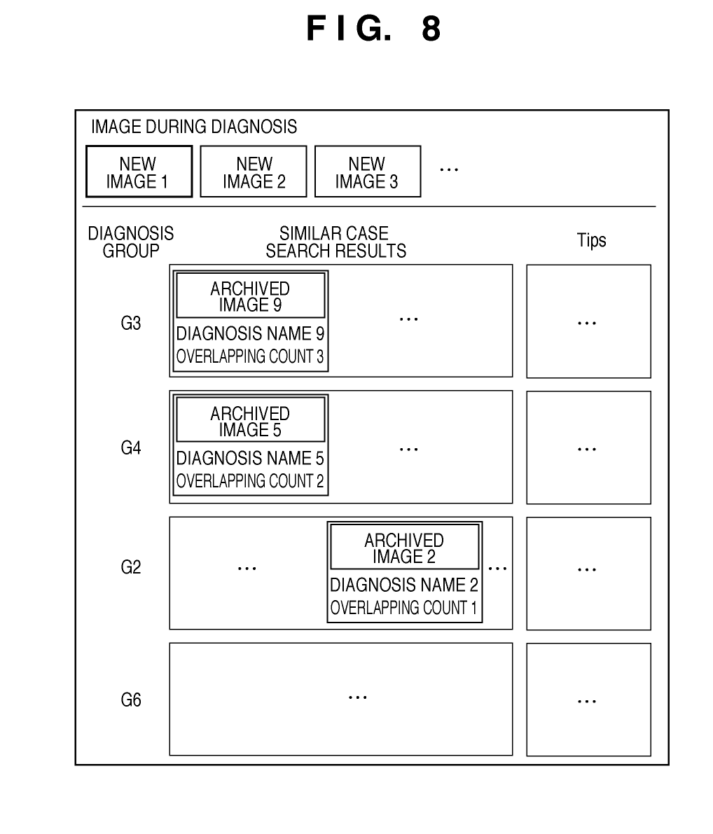

FIG. 8 exemplifies a window displayed as a result of the processing in step S380 of FIG. 3 according to the second embodiment. Most of the window example shown in FIG. 8 is the same as that shown in FIG. 7 except that data of each similar case is displayed as a diagnosis group-specific similar case search result. More specifically, the “overlapping count” between data of similar cases belonging to the same diagnosis group, which is calculated in step S650 of FIG. 6, is displayed together with image data and a definite diagnosis name. A doctor can recognize the number of similar case data very similar to other similar case data. In other words, a doctor who is to make an image diagnosis can check the “overlapping count” to know how often each similar case data appears in a case database 2. Instead of the “overlapping count”, another information (e.g., graph) derived from the overlapping count may be displayed.

As described above, the similar case search apparatus according to the second embodiment can extract a plurality of definite case data having different diagnosis results from the case database 2 for input indefinite case data. In particular, the similar case search apparatus according to the second embodiment can extract a wider range (various kinds) of definite case data in comparison with the first embodiment. By displaying the “overlapping count”, the degree of relation with input case data can be notified.

### Other Embodiments

The present invention is also achieved by executing the following processing. More specifically, software (program) for implementing the functions of the above-described embodiments is supplied to a system or apparatus via a network or various storage media. The computer (or the CPU or MPU) of the system or apparatus reads out and executes the program.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-246599, filed Sep. 25, 2008, which is hereby incorporated by reference herein in its entirety.

1. A data search apparatus which extracts at least data of one definite case from a case database that stores a plurality of definite case data including medical image data and definite diagnosis information corresponding to the medical image data, the apparatus characterized by comprising:
input acceptance unit for accepting input of case data including at least medical image data;
derivation unit for deriving a similarity between each of the plurality of definite case data stored in the case database and the case data input from said input acceptance unit;
classification unit for classifying the plurality of definite case data stored in the case database into a plurality of diagnosis groups, based on definite diagnosis information included in each of the plurality of definite case data; and
extraction unit for extracting, based on the similarity derived by said derivation unit, at least a predetermined number of definite case data from each of the plurality of diagnosis groups.

2. The data search apparatus according to claim 1, characterized in that said extraction unit changes an extraction criterion based on the similarity for each of the plurality of diagnosis groups classified by said classification unit.

3. The data search apparatus according to claim 1, characterized by further comprising:
selection unit for selecting, as a similar group from the plurality of diagnosis groups, a diagnosis group containing definite case data whose similarity with the case data is not lower than a predetermined threshold; and
setting unit for setting, as a related group for each of the plurality of diagnosis groups, at least another diagnosis group containing definite case data highly similar to definite case data in the diagnosis group,
wherein said extraction unit extracts, based on the similarity derived by said derivation unit, at least a predetermined number of definite case data from each of the similar group and the related group of the similar group.

4. The data search apparatus according to claim 3, characterized in that said selection unit selects only a predetermined number of definite case data in descending order of similarities derived by said derivation unit from the plurality of definite case data stored in the case database, and selects, as the similar group, a diagnosis group containing the selected definite case data.

5. A method of controlling a data search apparatus which extracts at least data of one definite case from a case database that stores a plurality of definite case data including medical image data and definite diagnosis information corresponding to the medical image data, the method characterized by comprising:
an input acceptance step of accepting input of case data including at least medical image data;
a derivation step of deriving a similarity between each of the plurality of definite case data stored in the case database and the case data input in the input acceptance step;
a classification step of classifying the plurality of definite case data stored in the case database into a plurality of diagnosis groups, based on definite diagnosis information included in each of the plurality of definite case data; and
an extraction step of extracting, based on the similarity derived in the derivation step, at least a predetermined number of definite case data from each of the plurality of diagnosis groups.

6. A data search system including a case database which stores a plurality of definite case data including medical image data and definite diagnosis information corresponding to the medical image data, and a data search apparatus which accesses the case database to extract at least data of one definite case, the system characterized by comprising:
input acceptance unit for accepting input of case data including at least medical image data;
derivation unit for deriving a similarity between each of the plurality of definite case data stored in the case database and the case data input from said input acceptance unit;
classification unit for classifying the plurality of definite case data stored in the case database into a plurality of diagnosis groups, based on definite diagnosis information included in each of the plurality of definite case data; and
extraction unit for extracting, based on the similarity derived by said derivation unit, at least a predetermined number of definite case data from each of the plurality of diagnosis groups.

7. A computer-readable storage medium storing thereon a program for causing a computer to function as each unit of a data search apparatus as defined in claim 1.
